(19) United States
(12) Patent Application Publication
(10) Pub. No.: US 2019/0337477 A1
(43) Pub. Date: Nov. 7, 2019

(54) AIRBAG CONTROL DEVICE AND CONTROL METHOD THEREOF

(71) Applicant: New Era AI Robotic Inc., Taipei City (TW)

(72) Inventor: Chi-Chang Tung, Taipei City (TW)

(73) Assignee: New Era AI Robotic Inc., Taipei City (TW)

(21) Appl. No.: 16/177,459

(22) Filed: Nov. 1, 2018

(30) Foreign Application Priority Data
May 2, 2018 (CN) 201810409320.0

(51) Int. Cl. B60R 21/015

(52) U.S. Cl. CPC B60R 21/01538; B60R 21/01536; B60R 21/01534

(57) ABSTRACT

An airbag control device and a control method thereof are provided. The airbag control device includes a sensor, a controller and a signal interceptor. The sensor is configured to sense a preset inflation space of an airbag. The controller is coupled to the sensor. The controller is configured to determine whether the preset inflation space is in a barrier free status. When the preset inflation space is not in the barrier free status, the controller outputs a control signal. The signal interceptor is coupled to the controller. The signal interceptor is configured to disable the airbag according to the control signal.

### CROSS-REFERENCE TO RELATED APPLICATION

This application claims the priority benefit of China application serial no. 201810409320.0, filed on May 2, 2018. The entirety of the above-mentioned patent application is hereby incorporated by reference herein and made a part of this specification.

### BACKGROUND OF THE INVENTION

### Field of the Invention

The invention relates to an airbag control approach, and particularly relates to an airbag control device and a control method thereof.

### Description of Related Art

In view of general vehicle safety equipment, airbags are essential safety equipment for most vehicles. When a vehicle collides, the airbag may receive an airbag explosion signal instantly outputted by an airbag activator device to inflate immediately to avoid collision between a passenger and an internal structure of the vehicle. However, for a passenger of a front passenger seat, if the passenger of the front passenger seat sits in an unusual manner or posture, when the vehicle collides, inflation of the airbag corresponding to the front passenger seat probably causes injury to the passenger of the front passenger seat. Moreover, in some cases, the injury caused by the airbag is probably higher than injury caused by collision of the vehicle. Therefore, it is important to provide a proper airbag actuation measure, and exemplary embodiments of several solutions are provided below.

### SUMMARY OF THE INVENTION

The invention is directed to an airbag control device and a control method thereof, which are adapted to determine whether an airbag is adapted to be properly actuated, so as to effectively protect a passenger.

The invention provides an airbag control device including a sensor, a controller and a signal interceptor. The sensor is configured to sense a preset inflation space of an airbag. The controller is coupled to the sensor. The controller is configured to determine whether the preset inflation space is in a barrier free status. When the preset inflation space is not in the barrier free status, the controller outputs a control signal. The signal interceptor is coupled to the controller. The signal interceptor is configured to disable the airbag according to the control signal.

The invention provides an airbag control method including following step: sensing a preset inflation space of an airbag by a sensor; determining whether the preset inflation space is in a barrier free status by a controller; when the preset inflation space is not in the barrier free status, outputting a control signal by the controller; and disabling the airbag by a signal interceptor according to the control signal.

According to the above description, the airbag control device and the airbag control method of the invention are adapted to determine whether the airbag is adapted to be inflated by determining the preset inflation space of the airbag, so as to effectively prevent the passenger from being injured by the inflated airbag.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an airbag control device according to an embodiment of the invention.

FIG. 2A is a schematic diagram illustrating configuration of a sensor according to an embodiment of the invention.

FIG. 2B is a schematic diagram illustrating configuration of a sensor according to another embodiment of the invention.

FIG. 3A is a schematic diagram of a depth map according to an embodiment of the invention.

FIG. 3B is a schematic diagram of another depth map according to another embodiment of the invention.

FIG. 4 is a flowchart illustrating an airbag control method according to an embodiment of the invention.

FIG. 5 is a flowchart illustrating an airbag control method according to another embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

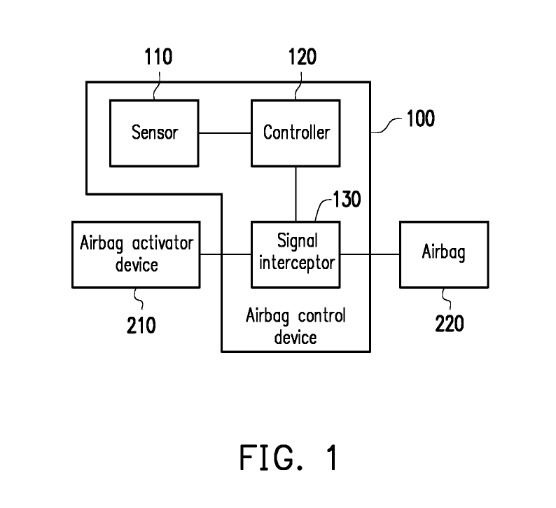

FIG. 1 is a schematic diagram of an airbag control device according to an embodiment of the invention. Referring to FIG. 1, the airbag control device 100 includes a sensor 110, a controller 120 and a signal interceptor 130. The controller 120 is coupled to the sensor 110 and the signal interceptor 130. The signal interceptor 130 is coupled to an airbag activator device 210 and an airbag 220. In the embodiment, the signal interceptor 130 is installed on a signal transmission path between the airbag activator device 110 and the airbag 220. In the embodiment, the airbag activator device 210 and the airbag 220 are installed in a vehicle at a place corresponding to a driver's seat. The airbag control device 100 may be an embedded device, or installed in the vehicle in an external connection manner, so as to connect the airbag activator device 110 and the airbag 220. It should be noted that the airbag 220 of the embodiment may be installed at a place corresponding to a front passenger seat, though the invention is not limited thereto. Moreover, the sensor 110 of the embodiment is, for example, a color video camera, a depth camera, an ultrasonic sensor or an infrared sensor.

In the embodiment, the sensor 110 senses a preset inflation space of the airbag 220. The controller 120 determines whether the preset inflation space is in a barrier free status. When the preset inflation space is not in the barrier free status, the controller 120 outputs a control signal to the signal interceptor 130, and the signal interceptor 130 controls an operation of the airbag 220 according to the control signal. To be specific, when the signal interceptor 130 receives the control signal, the signal interceptor 130 cuts off the signal transmission path between the airbag 220 and the airbag activator device 210, such that when the airbag activator device 210 sends an airbag explosion signal, the airbag explosion signal cannot be transmitted to the airbag 220. Conversely, when the signal interceptor 130 does not receive the control signal, the signal interceptor 130 does not cut off the signal transmission path between the airbag 220 and the airbag activator device 210, such that when the airbag activator device 210 sends the airbag explosion signal, the airbag explosion signal may be transmitted to the airbag 220.

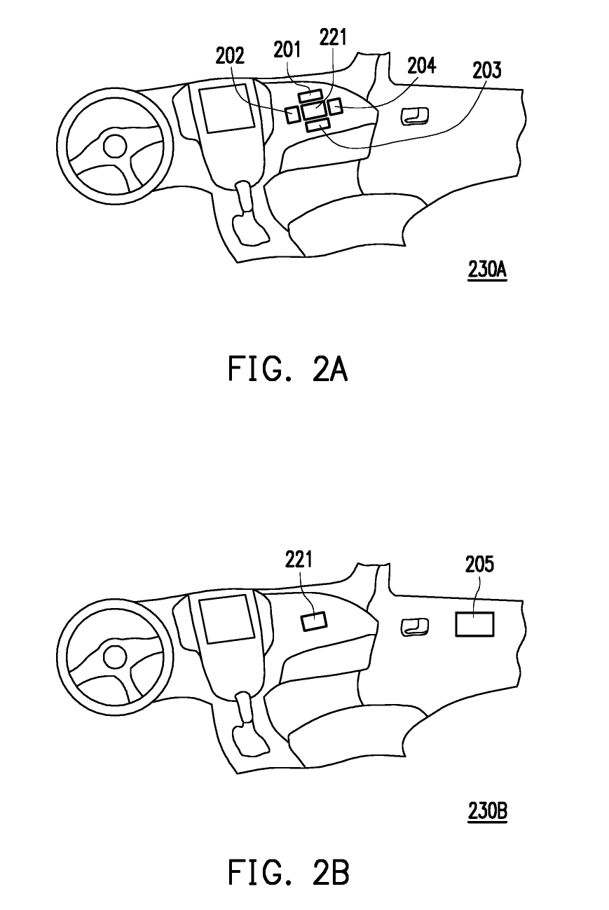

FIG. 2A is a schematic diagram illustrating configuration of a sensor according to an embodiment of the invention. Referring to FIG. 1 and FIG. 2A, FIG. 2A illustrates a vehicle interior space 230A. In the embodiment, a pop-up point 221 of the airbag 220 is, for example, located on a glove compartment or a dashboard in front of the front passenger seat, and the sensor 110 may be installed at an installation position 201 above the pop-up point 221, an installation position 202 located to the left of the pop-up point 221, an installation position 203 under the pop-up point 221, or an installation position 204 located to the right of the pop-up point 221. The sensor 110 is used for sensing in the direction of the front passenger seat, so as to detect whether the preset inflation space of the airbag 220 has a barrier.

For example, when a passenger of the front passenger seat places his legs on the glove compartment or the dashboard in front of the front passenger seat, the controller 120 analyzes a sensing result of the sensor 110 to determine that the preset inflation space of the airbag 220 has a barrier (the legs of the passenger). Therefore, the controller 120 outputs the control signal to the signal interceptor 130, and the signal interceptor 130 cuts off the signal transmission path between the airbag 220 and the airbag activator device 210. In other words, the airbag control device 100 may avoid impact on the legs of the passenger sitting on the front passenger seat due to inflation of the airbag 220.

FIG. 2B is a schematic diagram illustrating configuration of a sensor according to another embodiment of the invention. Referring to FIG. 1 and FIG. 2B, FIG. 2B illustrates a vehicle interior space 230B. In the embodiment, the pop-up point 221 of the airbag 220 is, for example, located on the glove compartment or the dashboard in front of the front passenger seat, and the sensor 110 may be installed at an installation position 205 at an inner side a vehicle door. The sensor 110 is used for sensing in the direction of the front passenger seat, so as to detect whether the preset inflation space of the airbag 220 has a barrier.

For example, when the passenger of the front passenger seat holds a mobile device, the controller 120 analyzes a sensing result of the sensor 110 to determine that the preset inflation space of the airbag 220 has a barrier (the handheld object of the passenger). Therefore, the controller 120 outputs the control signal to the signal interceptor 130, and the signal interceptor 130 cuts off the signal transmission path between the airbag 220 and the airbag activator device 210. In other words, the airbag control device 100 may avoid impact on the handheld object of the passenger due to inflation of the airbag 220, so as to avoid impact of the handheld object on the face of the passenger.

However, the installation position of the sensor 110 of the invention is not limited to the positions shown in FIG. 2A or FIG. 2B, and the installation position of the sensor 110 may be determined according to the type of the sensor. In an embodiment, the sensor 110 may also be installed on the front passenger seat or on an inside roof of the vehicle. Moreover, the improper sitting postures or improper behaviours of the passenger of the front passenger seat sensed by the sensor 110 of the invention are not limited to the examples mentioned in the aforementioned embodiments.

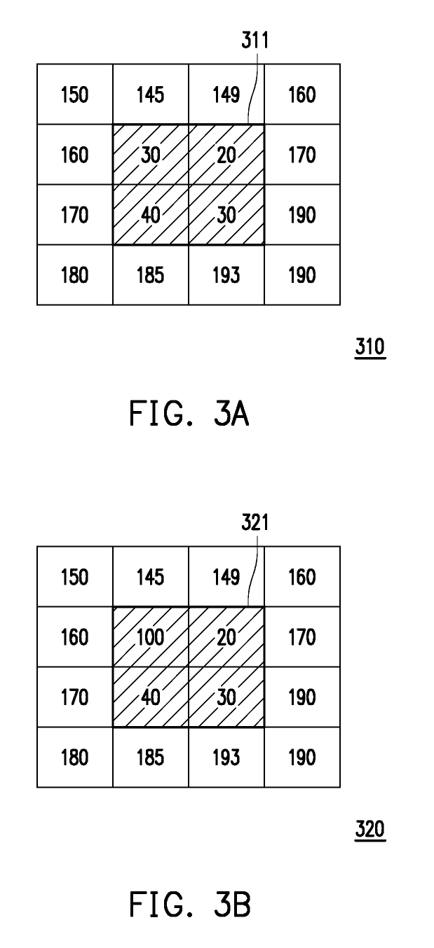

FIG. 3A is a schematic diagram of a depth map according to an embodiment of the invention. FIG. 3B is a schematic diagram of another depth map according to another embodiment of the invention. Referring to FIG. 1, FIG. 3A and FIG. 3B, the sensor 110 senses the preset inflation space of the airbag 220 to obtain depth information. In the embodiment, the depth information, for example, includes a depth map 310 or a depth map 320. The controller 120 analyzes the depth map 310 or the depth map 320 to determine whether at least one depth value in a specific region 311 of the depth map 310 or a specific region 321 of the depth map 320 (the oblique line region in FIG. 3A and FIG. 3B) is within a predetermined range, so as to determine whether the preset inflation space is not in the barrier free status. To be specific, the sensor 110 may obtain an image or a picture of the preset inflation space of the airbag 220, and the controller 120 may analyze the image or the picture to obtain the depth maps 310 of FIG. 3A or the depth map 320 of FIG. 3B. In FIG. 3A and FIG. 3B, the specific regions 311, 321 of the depth maps 310, 320 represent positions of the preset inflation space of the airbag 220. Namely, the controller 120 determines whether the positions of the present inflation space of the airbag 220 have a barrier.

In the embodiment, the controller 120 may set a preset range of the depth values, where the depth values may be represented by pixel values (or grayscale values) of corresponding pixels in the depth maps 310, 320, and the preset range is, for example, 50-150. Namely, the sensor 110 may determine whether a barrier exists in the preset inflation space with the depth values of 50-150 of the airbag 220. If the barrier exists in the preset inflation space with the depth values of 50-150 of the airbag 220, the depth value corresponding to at least one pixel in the specific region 311 of the depth map 310 or in the specific region 321 of the depth map 320 is between 50 and 150.

Taking FIG. 3A as an example, when the sensor 110 obtains the depth map 310 of FIG. 3A, and the depth values (30, 20, 30, 40) corresponding to the pixels in the specific region 311 of the depth map 310 are all not within the preset range of 50-150, the controller 120 determines that none barrier exists in the preset inflation space with the depth values of 50-150 of the airbag 220. In this case, the signal interceptor 130 does not cut off the signal transmission path between the airbag 220 and the airbag activator device 210.

Taking FIG. 3B as an example, when the sensor 110 obtains the depth map 320 of FIG. 3B, and one of the depth values (100, 20, 30, 40) corresponding to the pixels in the specific region 321 of the depth map 320 is within the preset range of 50-150, the controller 120 determines that a barrier exists in the preset inflation space with the depth values of 50-150 of the airbag 220. In this case, the signal interceptor 130 cuts off the signal transmission path between the airbag 220 and the airbag activator device 210.

It should be noted that the sensor 110 of the embodiment is, for example, a depth camera. The depth camera may sense the preset inflation space of the airbag 220 to obtain the depth map of FIG. 3A or FIG. 3B, though the invention is not limited thereto. In an embodiment, the sensor 110 may include a plurality of ultrasonic sensors or a plurality of infrared sensors, which are, for example, installed at a plurality of installation positions in the vehicle space shown in FIG. 2A or FIG. 2B, and each of the ultrasonic sensors or the infrared sensors may detect a distance of the barrier in the front, where a reading value of each of the ultrasonic sensors or the infrared sensors may be set to infinite or 255 (as a range of 0-255 of the pixel values or the depth values) to represent that none barrier is detected. Therefore, each of the ultrasonic sensors or the infrared sensors may obtain the depth map of FIG. 3A or FIG. 3B. However, in another embodiment, the sensor 110 may include two or more RGB cameras to respectively obtain at least two color images. Moreover, the controller 120 may execute a depth computation algorithm according to the at least two color images to obtain the depth map of FIG. 3A or FIG. 3B.

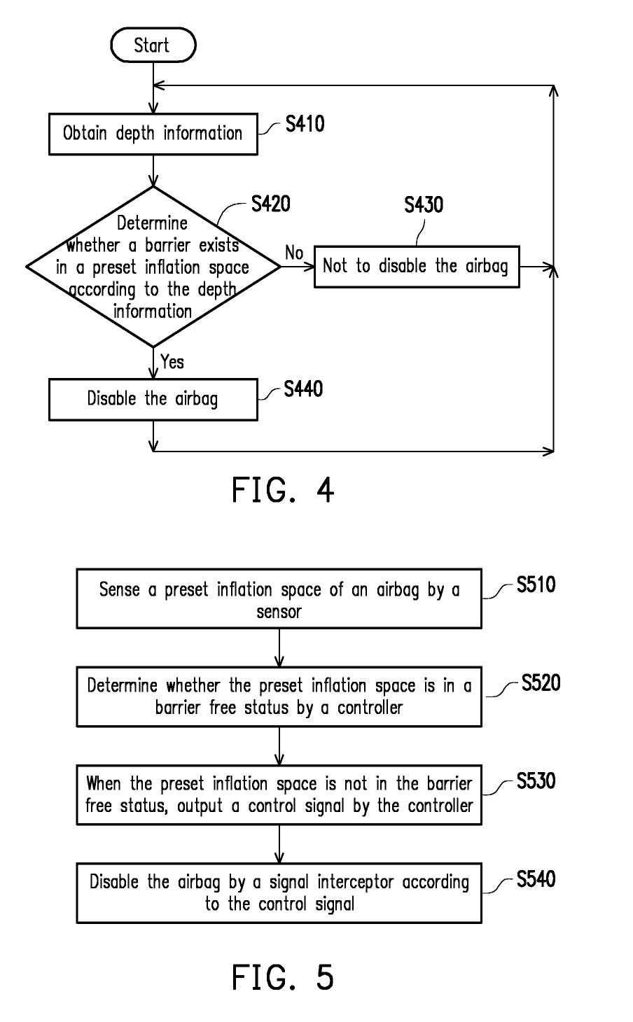

FIG. 4 is a flowchart illustrating an airbag control method according to an embodiment of the invention. Referring to FIG. 1 and FIG. 4, the airbag control method of FIG. 4 is at least adapted to the airbag control device 100 of FIG. 1. When the vehicle is started, the airbag control device 100 is started to execute steps S410-S440. In the step S410, the sensor 110 obtains depth information. In step S420, the controller 120 determines whether a barrier exists in the preset inflation space of the airbag 220 according to the depth information. If none barrier exists in the preset inflation space of the airbag 220, in step S430, the controller 120 does not disable the airbag 220. Conversely, if the barrier exists in the preset inflation space of the airbag 220, in step S440, the controller 120 disables the airbag 220. Therefore, the airbag control method of the embodiment may effectively determine whether the airbag 220 is adapted to be inflated, so as to determine whether the airbag may be activated.

Moreover, those skilled in the art may learn enough instructions and recommendations for device features of the airbag control device 100, the obtaining method of the depth information or the disabling manner of the airbag 220 from the descriptions of the embodiments of FIG. 1 to FIG. 3B, and detailed description thereof is not repeated.

FIG. 5 is a flowchart illustrating an airbag control method according to another embodiment of the invention. Referring to FIG. 1 and FIG. 5, the airbag control method of FIG. 5 is at least adapted to the airbag control device 100 of FIG. 1. In step S510, the airbag control device 100 senses the preset inflation space of the airbag 220 by using the sensor 110. In step S520, the airbag control device 100 determines whether the preset inflation space is in a barrier free status by using the controller 120. In step S530, when the controller 120 determines that the preset inflation space is not in the barrier free status, the airbag control device 100 outputs a control signal to the signal interceptor 130 by using the controller 120. In step S540, the signal interceptor 130 disables the airbag 220 according to the control signal. Therefore, the airbag control method of the embodiment may effectively determine whether a barrier exists in the preset inflation space of the airbag 220, so as to determine whether the airbag may be activated.

Moreover, those skilled in the art may learn enough instructions and recommendations for device features of the airbag control device 100, the obtaining method of the depth information or the disabling manner of the airbag 220 from the descriptions of the embodiments of FIG. 1 to FIG. 4, and detailed description thereof is not repeated.

In summary, the airbag control device and the airbag control method of the invention may use the sensor to detect the preset inflation space of the airbag, so as to effectively determine whether a barrier exists in the preset inflation space of the airbag. Therefore, if the barrier exists in the preset inflation space of the airbag, the signal interceptor cuts off the signal transmission path between the airbag activator device and the airbag. Conversely, if none barrier exists in the preset inflation space of the airbag, the signal interceptor does not cut off the signal transmission path between the airbag activator device and the airbag. In this way, the airbag control device and the airbag control method of the invention may effectively determine whether the airbag is adapted to be inflated, so as to effectively avoid injury of the passenger caused by inflation of the airbag.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An airbag control device, comprising:
a sensor, configured to sense a preset inflation space of an airbag;
a controller, coupled to the sensor, and configured to determine whether the preset inflation space is in a barrier free status, wherein when the preset inflation space is not in the barrier free status, the controller outputs a control signal; and
a signal interceptor, coupled to the controller, and configured to disable the airbag according to the control signal.

2. The airbag control device as claimed in claim 1, wherein the sensor senses the preset inflation space of the airbag to obtain depth information, and the controller determines whether the preset inflation space is in the barrier free status according to the depth information.

3. The airbag control device as claimed in claim 2, wherein the depth information comprise a depth map, and the controller analyzes the depth map to determine whether at least one depth value in a specific region of the depth map is within a preset range, so as to determine whether the preset inflation space is not in the barrier free status.

4. The airbag control device as claimed in claim 3, wherein the preset range is 50-150.

5. The airbag control device as claimed in claim 1, wherein when the signal interceptor receives the control signal, the signal interceptor cuts off a signal transmission path between the airbag and an airbag activator device, such that when the airbag activator device sends an airbag explosion signal, the airbag explosion signal is not transmitted to the airbag.

6. The airbag control device as claimed in claim 1, wherein the sensor is disposed at an inner side of a vehicle door near a front passenger seat, a dashboard, a glove compartment, the front passenger seat or an inside roof, and the sensor is configured to detect the preset inflation space of the airbag of the front passenger seat.

7. The airbag control device as claimed in claim 1, wherein the sensor is a color camera, a depth camera, an ultrasonic sensor or an infrared sensor.

8. An airbag control method, comprising:
sensing a preset inflation space of an airbag by a sensor;
determining whether the preset inflation space is in a barrier free status by a controller;
when the preset inflation space is not in the barrier free status, outputting a control signal by the controller; and
disabling the airbag by a signal interceptor according to the control signal.

9. The airbag control method as claimed in claim 8, wherein the sensor senses the preset inflation space of the airbag to obtain depth information, and the step of determining whether the preset inflation space is in the barrier free status by the controller comprises:
determining whether the preset inflation space is in the barrier free status by the controller according to the depth information.

10. The airbag control method as claimed in claim 8, wherein the depth information comprise a depth map, and the step of determining whether the preset inflation space is in the barrier free status by the controller according to the depth information comprises:
analyzing the depth map by the controller to determine whether at least one depth value in a specific region of the depth map is within a preset range, so as to determine whether the preset inflation space is not in the barrier free status.

11. The airbag control method as claimed in claim 10, wherein the preset range is 50-150.

12. The airbag control method as claimed in claim 8, wherein the step of disabling the airbag by the signal interceptor according to the control signal comprises:
when the signal interceptor receives the control signal, cutting off a signal transmission path between the airbag and an airbag activator device by the signal interceptor, such that when the airbag activator device sends an airbag explosion signal, the airbag explosion signal is not transmitted to the airbag.

13. The airbag control method as claimed in claim 8, wherein the sensor is disposed at an inner side of a vehicle door near a front passenger seat, a dashboard, a glove compartment, or an inside roof, and the sensor is configured to detect the preset inflation space of the airbag of the front passenger seat.

14. The airbag control method as claimed in claim 8, wherein the sensor is a color camera, a depth camera, an ultrasonic sensor or an infrared sensor.
